(19) United States
(12) Patent Application Publication
(10) Pub. No.: US 2022/0380913 A1
(43) Pub. Date: Dec. 1, 2022

(54) PERFORATED PLATE STRUCTURE, SUCH AS AN ELECTRODE

(71) Applicant: VECO B.V., Eerbeek (NL)

(72) Inventor: Harm Gerrit Knol, Eerbeek (NL)

(73) Assignee: VECO B.V., Eerbeek (NL)

(21) Appl. No.: 17/755,921

(22) PCT Filed: Nov. 6, 2020
(86) PCT No.: PCT/NL2020/050695

§ 371 Date: May 11, 2022

(30) Foreign Application Priority Data
Nov. 14, 2019 (NL) 2024234

(51) Int. Cl. C25B 11/03; C25B 11/042; C25B 11/046

(52) U.S. Cl. CPC C25B 11/03; C25B 11/042; C25B 11/046; C02F 1/46109

(57) ABSTRACT

A plate structure, such as a plate electrode, comprising two outer layers and an intermediate layer. Both outer layers are provided with a pattern of recesses, such as hexagonal or circular recesses. The recesses on one outer layer are offset with respect to the recesses in the other outer layer. The intermediate layer comprises through-holes, each through-hole connecting a recess at one outer layer with a partially overlapping recess at the opposite outer layer.

The invention relates to a perforated plate structure, such as a gas diffusion electrode, e.g., for the electrolysis of water to produce hydrogen and oxygen or for water purification or similar electrolysis processes, or fuel cells.

Electrodes for the electrolysis of water form an interface supporting an electrochemical reaction between a liquid phase and a gaseous phase. The electrode must facilitate sufficient mass flow, or mass transfer, as well as electric conductivity and mechanical stability. Mesh electrodes or perforated plate electrodes can be used to optimize mass flow and to increase the surface area available for the electrochemical reaction. The openings in the electrodes should be sufficiently large to prevent gas stagnation. Typically the electrodes comprise a catalyst material, e.g., as a coating, to catalyze the desired electrochemical reaction.

It is an object of the invention to provide a structure that can for example be used as a perforated plate electrode for electrolysis processes, combining a large surface area and increased mass flow with sufficient mechanical stability.

The object of the invention is achieved with a metal plate structure comprising two outer layers and at least one intermediate layer, wherein both outer layers are provided with a pattern of recesses, the recesses on one outer layer being offset or staggered with respect to the recesses in the other outer layer. The intermediate layer comprises through-holes, each through-hole connecting a recess at one outer layer with a partially overlapping recess at the opposite outer layer. The perforated plate structure combines a high mechanical stability and flatness with enlarged specific surface area and facilitates increased mass flow. Due to its flatness and mechanical stability the perforated plate structure can make good conductive contact with an adjacent proton or anion exchange membrane. Therefore, the perforated plate structure is particularly suitable for use as an electrode, in particular for electrolytic hydrogen production or for use in a fuel cell stack, e.g., at either side of a membrane or separator. The plate structure can be embodied with plane outer surfaces, e.g., only interrupted by the recesses, which makes it possible to realize a zero-gap configuration, e.g., for PEM and AEM electrodes. The perforated plate structure can also be used as an electrode for water purification or desalination, or similar gas forming electrolysis processes. The perforated plate structure can also be used for other purposes, such as a screen or sieve.

In this respect, plate structure means that the layers form an integral structure of the same material, such as a corrosion resistant steel, nickel, titanium, niobium or alloys thereof, or plastic materials or other suitable materials. The plate does not, or at least not necessarily, show materially distinctive layers. The expressions “inner layer” and “outer layer” refer to the position of the through-holes and recesses rather than referring to distinctive material layers.

In a specific embodiment, the recesses at the outer layers are of equal size, shape and spacing, separated by partitions of even thickness, wherein partitions at one outer layer join each other at junctions between three or four adjacent recesses. The junctions of the partitions of one outer layer can for example be aligned with the centers of the recesses of the opposite outer layer. This results in a very regular and mechanically stable structure. Alternatively, the recesses may have varying sizes, shapes and/or spacings.

In a specific embodiment, each recess at one outer layer partly overlaps three or more adjacent recesses of the opposite outer layer, and the through-holes are formed where a recess of one outer layer overlaps a recess of the opposite outer layer. Hence, each recess encircles at least three through-holes leading to at least three different recesses at the opposite outer layer.

The recesses can for example have a maximum width of at most 2 mm, e.g. at most 1 mm, e.g., at most 100 micron, e.g. at least 10 micron. The through-holes can have a diameter of at least 10 micrometers, e.g. at most 4 mm. Larger through-holes and/or recesses can also be used, if so desired. In a specific example the partitions may have a width of at most 2 mm, e.g., at most 1 mm, e.g., at least 10 micron. The plates structure may for example have a thickness of at most 2 mm, e.g. at most 1 mm, e.g., at most 300 micron, e.g., at most 100 micron, e.g., at least 10 micron.

Size, shape and spacing of the recesses and through holes can be varied depending on the intended use of the plate structure, e.g., as a cathode or as an anode. Also within a single plate structure, the size, shape and spacing of the recesses and through holes can be varied, e.g., to optimize electric current flow or the discharge of gas bubbles formed at the electrode surface.

All layers can be made from the same starting metal plate or sheet, for example be made by etching, for example micro-etching and/or electrochemical etching. The recesses can be etched in the usual manner, using a regular photo-resist material to mask the partitions. When the recesses are sufficiently deep, through-holes will be formed where the recesses overlap recesses at the opposite outer layer. The starting plate can be materially homogeneous over its thickness, but starting plates with a layered structure can also be used, if so desired.

Before etching, both sides of the starting plate are cleaned and coated with a light-sensitive photoresist. Parts of the photoresist layer are then selectively exposed to actinic radiation, in particular light, more in particular UV light. The photoresist can for example be a positive photoresist, in which the portion of the photoresist that is exposed to light becomes soluble to the photoresist developer, while the unexposed portion of the photoresist remains insoluble to the photoresist developer. Or the photoresist can be a negative photoresist. In that case, the portion of the photoresist that is exposed to light becomes insoluble to the photoresist developer, while the unexposed portion of the photoresist is dissolved by the photo-resist developer.

Selective exposure of the photoresist can for example be achieved by using a mask or by using Laser Direct Imaging (LDI) technology, allowing projections of high resolution images, e.g., directly from a CAD file.

The actinic radiation cures the photoresist. In a next step, the parts of the photoresist layers that are soluble for the developer, are washed away. The remaining part of the photo-resist reflects the desired pattern of partitions. The metal is bare where the recesses are to be etched.

In a next step, both sides of the plate are exposed to an etching medium, e.g., in a bath or as a spray. Examples of suitable etching fluids are for instance FeCl₃, FeNO₃, CuCl₂, and HF. Suitable etching techniques are for instance disclosed in the handbook Principles and Practice of Photochemical Machining and Photoetching, of D. Allen, published by Adam Hilger, 1986.

Both sides of the starting plate can be etched simultaneously. Optionally, different spraying pressures can be used at the two sides of the plate and/or a different number of etching units can be used at the two sides of the plate. This makes it possible to have different etching depths at the two sides. Optionally, different spraying pressures can be used at different sections of the same side of the plate.

In a final step the remaining photoresist is removed, e.g., using a suitable solvent or cleaning medium. A burr free and stress free perforated plate structure remains.

Other machining techniques, such as mechanical machining, can also be used, if so desired.

Optionally, a coating can be used enhancing the specific surface area, particularly if the plate is used as a perforated plate electrode for electrolysis processes. Such coatings may for example be applied using sol-gel technology or dynamic hydrogen bubble template synthesis (DHBT).

Thin layers of catalysing materials can be applied on the electrode, for example by means of vapor deposition, sputtering or electrostatic spraying. Suitable catalysts include, but are not limited to platinum, palladium, yttrium, vanadium molybdenum, tellurium, Raney nickel or mixtures thereof.

Other methods to increase specific surface area include mechanical treatments to increase surface roughness.

The perforated plate structure will typically be flat, but it may also be shaped with a different geometry, e.g., as a cylinder.

The invention is further explained with reference to the accompanying drawings showing exemplary embodiment.

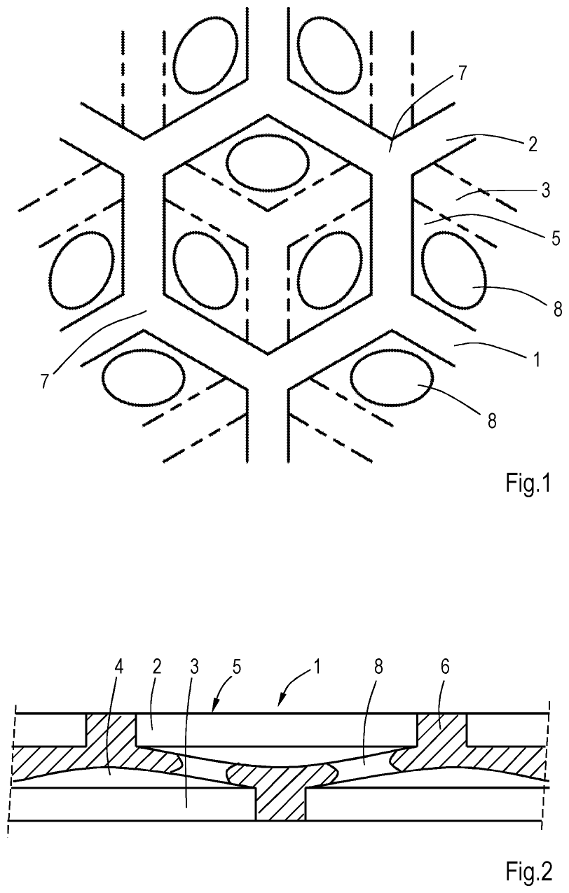

FIG. 1: shows a section of a plate structure according to the invention;

FIG. 2: shows a cross section of the structure along line I-I in FIG. 1.

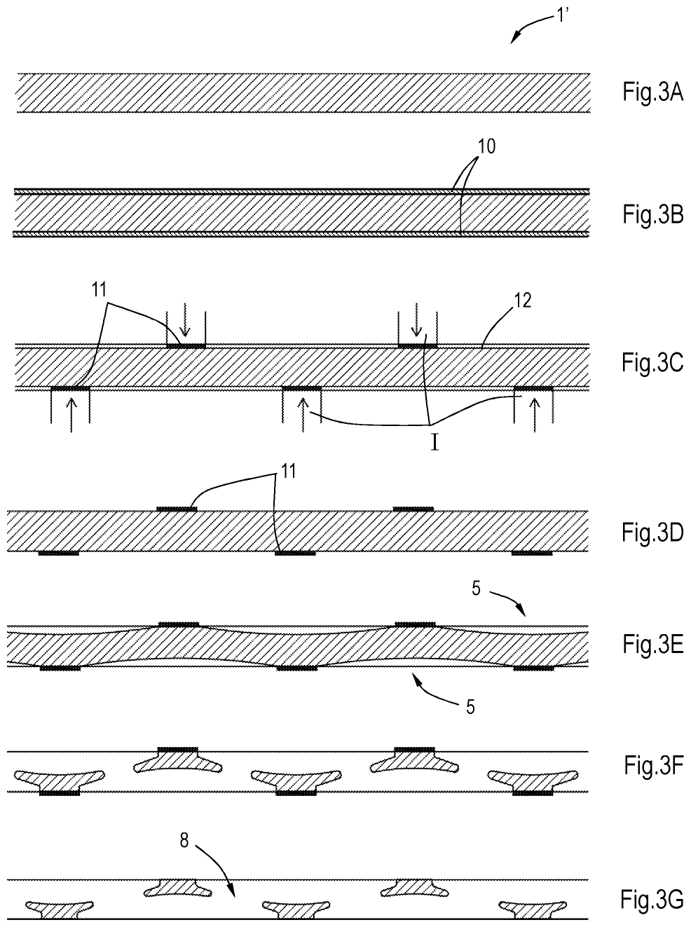

FIGS. 3A-G: show consecutive steps of a micro-etching process for manufacturing the plate structure of FIG. 1.

FIGS. 1 and 2 show a metal plate structure 1 comprising two outer layers 2, 3 and an intermediate layer 4. In FIG. 1, the pattern of the outer layer 2 facing the viewer is represented in drawn lines, while the pattern of the opposite outer layer 3 is drawn in dashed lines.

In the shown exemplary embodiment, both outer layers 2, 3 are provided with a honeycomb pattern of hexagonal recesses 5. In the shown embodiment, the recesses 5 at the two outer layers 2, 3 are of equal size, shape and spacing, and are separated by partitions 6 of even thickness. In alternative embodiments, the outer layers 2, 3 can have different thicknesses and/or the recesses may have varying geometries. The partitions 6 join each other at junctions 7 between three adjacent recesses 5. This results in a very dense arrangement of recesses 5 and, consequently, in a very high specific surface area. The recesses 5 on one outer layer 2 are offset with respect to the recesses 5 of the opposite outer layer 3, in such a way that junctions 7 of the partitions 6 of one outer layer 2 are aligned with the centers of the recesses 5 of the opposite outer layer 3.

The plate structure 1 has plane outer surfaces interrupted only by the recesses 5.

The intermediate layer 4 comprises through-holes 8. Each through-hole 8 connects a recess 5 at one outer layer 2 with a partially overlapping recess 5 at the opposite outer layer 3.

The outer layers 2, 3 and the intermediate layer 4 integrally form a single plate of a single metal or metal alloy material.

FIGS. 3A-F show consecutive steps of a micro-etching process for manufacturing the perforated metal plate structure 1. A starting plate or sheet 1′ of nickel, a nickel alloy, a corrosion resistant steel or any other suitable etchable material, is first cleaned, typically in a clean room, in order to optimize adhesion to a layer 10 of a light-sensitive photoresist material, applied in a next step on both sides of the plate 1′ (FIG. 3B). The photoresist material is exposed to actinic radiation, in particular to UV light, and subsequently washed with a photoresist developer. The remaining part of the photoresist images the desired pattern of partitions 6.

Using Laser Direct Imaging (LDI) technology (reschematically represented by arrows I in FIG. 3C), laser sources directly image a desired pattern of cured photoresist material 11 on both sides of the plate 1′. The imaged pattern at one side of the plate is identical to the pattern at the other side, but offset. If a negative photoresist is used, then the photoresist cures where it is affected by the laser beam, but the other parts 12 of the photoresist remains removable by means of a photoresist developer.

In a next step (FIG. 3D) the plate 1′ is washed to remove the uncured parts 12 of the photoresist. The cured parts 11 of the photoresist remain and reflect the honeycomb pattern of the partitions 6 of the perforated plate structure 1 to be made.

In a next step (FIG. 3E), an etching fluid is sprayed over both sides of the plate 1. The cured photoresist 11 is resistant to the etching fluid and shields the metal directly underlying the cured photoresist parts. The etching fluid etches the hexagonal recesses 5, which gradually grow deeper. At a certain depth of the hexagonal recesses 5, through-holes 8 will occur connecting a hexagonal recess 5 at one side of the plate with an overlapping hexagonal recess 5 at the opposite side of the plate 1 (FIG. 3F). In a final step (FIG. 3G), the cured photoresist 11 is washed away, and the desired perforated plate structure 1 is ready. Optionally, it can be treated further, e.g., by applying a coating enhancing catalytic activity or enhancing specific surface area.

1. A plate structure comprising two outer layers and at least one intermediate layer, wherein both outer layers are provided with a pattern of recesses, the recesses on one outer layer being offset with respect to the recesses in the other outer layer, and wherein the at least one intermediate layer comprises through-holes, each said through-hole connecting one said recess at one said outer layer with one said partially overlapping recess at the opposite outer layer.

2. The plate structure according to claim 1, wherein the recesses at the outer layers are of equal size, shape and spacing, separated by partitions of even thickness, wherein the partitions join each other at junctions between three or four adjacent said recesses.

3. The plate structure according to claim 2, wherein the junctions of the partitions of one said outer layer are aligned with centers of the recesses of the opposite outer layer.

4. The plate structure according to claim 3, wherein each recess at one said outer layer partly overlaps at least three adjacent recesses of the opposite outer layer, and the through-holes are formed where one said recess of one said outer layer overlaps a one said recess of the opposite outer layer.

5. The plate structure according to claim 1, wherein the recesses include circular, square and/or polygonal recesses.

6. The plate structure according to claim 1, wherein the through-holes have a diameter of at least 10 micrometers.

7. The plate structure according to claim 1, wherein the largest width of the recesses is in a range of at most 2 mm.

8. The plate structure according to claim 1, having a thickness in a range of at most 2 mm.

9. The plate structure according to claim 1, wherein the structure is made of a plastic material or a metal plate.

10. The plate structure according to claim 1, having planar outer surfaces.

11. An electrolyzer comprising an anode and/or cathode formed by the plate structure according to claim 1.

12. A method of manufacturing a plate structure according to claim 1 comprising a step of etching.

13. The method according to claim 12, wherein the recesses are etched until a depth where the through-holes appear.

14. The plate structure according to claim 5, wherein the recesses comprise hexagonal recesses.

15. The plate structure according to claim 7, wherein the largest width of the recesses is in a range of at most 1 mm.

16. The plate structure according to claim 7, wherein the largest width of the recesses is in a range of at most at most 100 microns.

17. The plate structure according to claim 7, wherein the largest width of the recesses is in a range of. at most at most 10 microns.

18. The plate structure according to claim 1, wherein the plate structure has a thickness in a range of. at most 1 mm.

19. The plate structure according to claim 1, wherein the plate structure has a thickness in a range of. at most 100 microns.

20. The plate structure according to claim 9, wherein the structure is made of a material selected from the group consisting of corrosion resistant steel, nickel, titanium, niobium or alloys thereof.
